(19) United States
(12) Patent Application Publication
(10) Pub. No.: US 2014/0331298 A1
(43) Pub. Date: Nov. 6, 2014

(54) Remote Patient Monitoring

(71) Applicant: WELCH ALLYN, INC, Skaneateles Falls, NY (US)

(72) Inventors: Steven D. Baker, Beaverton, OR (US); Bill Jay Quatier, Vancouver, WA (US)

(73) Assignee: Welch Allyn, Inc, Skaneateles Falls, NY (US)

(21) Appl. No.: 13/887,854

(22) Filed: May 6, 2013

(51) Int. Cl. H04L 29/06; H04W 12/06

(52) U.S. Cl. CPC H04L 63/029; H04W 12/06; H04L 63/0272
USPC 726/7; 726/11; 726/15

(57) ABSTRACT

A method for securely transmitting medical data to and from a remote location includes configuring a first electronic computing device with provisioning information to access a firewall-protected electronic data network. Medical data is received at the first electronic computing device from a second electronic computing device. The medical data is transmitted to the firewall-protected electronic data network using the first electronic computing device. The provisioning information permits a secure connection between the second electronic computing device and a third electronic computing device on the firewall-protected electronic data network.

### BACKGROUND

Patients with medical conditions often have a need to be monitored outside of a medical facility, for example in a patient's home or in an ambulance. Often, standard monitoring equipment is used, equipment that may be similar or identical to monitoring equipment used inside the medical facility.

Medical facilities, such as a hospital, typically have secure data networks, often including firewalls that protect against unauthorized access. When patients who are monitored outside of the medical facility need to transmit medical data to the medical facility, a secure connection typically needs to be established from a location where the patient is being monitored to the medical facility. However, server computers in the medical facility are often inaccessible from outside of the medical facility. For instances when the server computers are accessible from outside of the medical facility, obtaining a secure connection to the server computers may be difficult.

### SUMMARY

Embodiments of the disclosure are directed to a method for securely transmitting medical data to and from a remote location, the method comprising: configuring a first electronic computing device with provisioning information to access a firewall-protected electronic data network; receiving at the first electronic computing device medical data from a second electronic computing device; and transmitting the medical data to the firewall-protected electronic data network using the first electronic computing device, wherein the provisioning information permits a secure connection between the second electronic computing device and a third electronic computing device on the firewall-protected electronic data network.

In another aspect, a patient monitoring system comprises: a patient monitor device that includes a first radio device, the patient monitor device being located at a first location; a first access point device that includes a second radio device and at least one uplink port, the first access point device being located at the first location, the first access point device being provisioned to include authentication credentials for supporting an automatic connection to a first electronic device at a second location; and a second electronic device for receiving a connection from the uplink port, the second electronic device being located at the first location, the second electronic device supporting a connection to the Internet.

In yet another aspect, a method for securely transmitting medical data from a remote location comprises: at the remote location, installing a remote access electronic computing device, the remote access electronic computing device being provisioned with access and authentication information for accessing a firewall protected computer network; after the remote access electronic computing device is installed, automatically establishing an encrypted tunnel connection from the remote access electronic computing device to an electronic computing device on the firewall protected computer network; at the remote location, establishing a connection between a patient monitor device and the remote access electronic computing device; and transmitting medical data from the patient monitor device to the remote access electronic computing device, wherein, when the medical data is received at the remote access electronic computing device, the medical data is transmitted on the encrypted tunnel connection to the electronic computing device on the firewall protected computer network.

The details of one or more techniques are set forth in the accompanying drawings and the description below. Other features, objects, and advantages of these techniques will be apparent from the description, drawings, and claims.

### DESCRIPTION OF THE DRAWINGS

FIG. 1 shows an example system that supports remote patient monitoring.

FIG. 2 shows example components of a medical facility of the system of FIG. 1.

FIG. 3 shows an example flowchart for securely transferring medical data from a remote patient monitor device.

FIG. 4 shows example physical components of a patient monitor and remote access point of FIG. 1.

### DETAILED DESCRIPTION

The present disclosure is directed to systems and methods for remote monitoring of patients. Using the systems and methods, medical data from a patient being monitoring at a remote location is securely transferred from the remote location to a medical facility. The remote location is typically a fixed location, such as a patient's home or a mobile location, such as a medical transport. Another example of the fixed location is a kiosk in a mall. Examples of the medical transport include an ambulance, a life flight airplane, a military air transport airplane and a hospital ship. Other examples of the fixed and mobile locations are possible. The remote location can be any location in the world from which medical data may be transmitted.

In order to transfer the medical data, a secure connection is made from the remote location to an electronic computing device, typically a server computer, at the medical facility. The secure connection is made through a remote access point at the remote location. Using the systems and methods, the remote access point is configured with information to permit access to a network at the medical facility.

The configured information may include an authentication method, encryption information, authentication credentials, and radio frequency (RF) settings such as a delivery traffic indication message (DTIM) interval, transmission power and regulatory constraint elements. Authentication credentials may include a user name, a password, a security certificate or combinations thereof. Other types of configured information are possible. The configuration of the remote access point with information to permit access to the network at the medical facility may also be referred to as provisioning the remote access point.

The remote access point (RAP) is an electronic computing device that provides access to server computers and other electronic computing devices at the medical facility. Other access points may be provided within the medical facility. The remote access point is an access point which is used at the remote location. The remote access point is typical of an access point used within the medical facility.

A secure connection, typically an encrypted tunnel, is established between the remote access point and an access point at the medical facility. One example of an encrypted tunnel is a virtual private network (VPN). In this disclosure, the secure connection is referred to as the VPN.

The RAP is pre-configured with security information needed to obtain the secure connection. For example, the RAP may be pre-configured with a user name, password and other access and authentication information, for example a security code, that may be needed to authenticate the patient at the server computer and that may be needed to overcome a firewall at the medical facility. In this disclosure, a process for configuring a RAP may also be referred to as provisioning the RAP. The firewall may also need to be configured to permit data of a specific type to a specific IP address of an access point controller at the medical facility, using a specific port.

When the RAP is provisioned, patient medical data from monitoring equipment at the remote location is automatically transmitted via the VPN to a server computer at the medical facility. In addition, the VPN remains active even when the remote location changes. For example, patient medical data transmitted from a RAP in an ambulance, continues to be transmitted to the server computer when the patient arrives at the medical facility and is transferred into the medical facility. When the patient arrives at the medical facility, the monitoring equipment may change an association from the RAP to a local access point in the medical facility. When the monitoring equipment changes association to the local access point, the same authentication and encryption is used as during transport of the patient and monitoring equipment in the ambulance.

The systems and methods disclosed support patient monitoring equipment that is HIPAA compliant. HIPAA refers to the Health Insurance Portability and Accountability Act. HIPAA compliance requires compliance with standards for securely transmitting patient data, typically using an encrypted tunnel. The systems and methods permit a medical grade HIPAA compliant medical device to be installed and used anywhere in the world without configuration of the medical device for secure transmission of the patient data and without any special configuration of Internet/Intranet connections at the remote location.

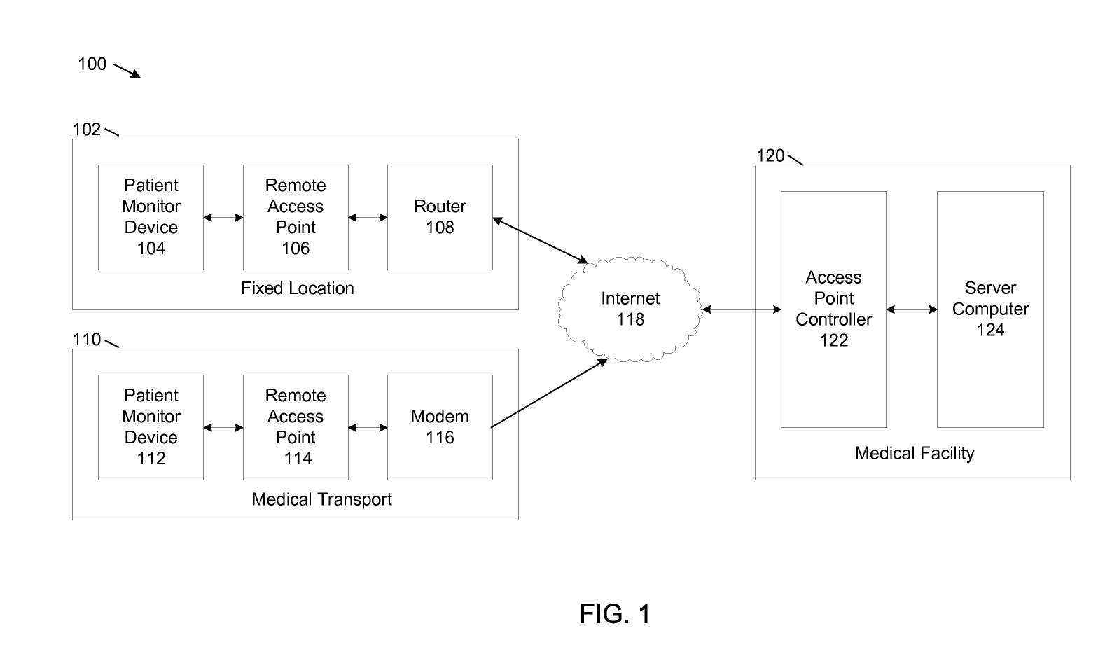

FIG. 1 shows an example system 100 that supports remote patient monitoring. The example system 100 includes remote locations 102 and 110, Internet 118 and a medical facility 120. In the example system 100, remote location 102 is a patient home and remote location 110 is an ambulance. In the example system 100, the medical facility 120 is a hospital. Different types of remote locations and medical facilities are possible.

The remote location 102 includes a patient monitor device 104, a remote access point 106 and a router 108. The remote location 110 includes a patient monitor device 112, a remote access point 114 and a modem 116. The patient monitor devices 104, 112 are medical devices that monitor medical parameters from a patient. More than one patient monitor device 104, 112 may be used at remote locations 102, 110. An example patient monitor device is the Propaq® LT patient monitor from Welch Allyn Inc. of Skaneateles Falls, N.Y.

The remote access points 106, 114 are electronic computing devices that provide secure wired and wireless access to medical facility 120 from remote locations 102 and 110, respectively. For example, RAP 106 provides either a wired or wireless connection to patient monitor device 104 and RAP 114 provides a wired or wireless connection to patient monitor device 112. From RAP 106 or RAP 114, a wired or wireless connection is typically made to an Internet access device. An example remote access point is the RAP-5 remote access point provided by Aruba Networks, Inc. of Sunnyvale, Calif.

In the example system 100, for fixed remote location 102, the Internet access device for RAP 106 is router 108, and for mobile remote location 110, the Internet access device for RAP 114 is modem 116. In the example system 100, router 108 is a home router that receives a wired or wireless connection, for example an Ethernet connection, from RAP 106 and for which router 108 provides a wired connection to the Internet. In the example system 100, modem 116 receives a wired or wireless connection, from RAP 114 and provides a wireless connection to the Internet. In other examples, different Internet access devices and different configurations for RAP connections to the Internet access devices may be used. In other examples, fixed remote location 102 may use a modem in lieu of router 108.

In some examples, patient monitor device 104 and RAP 106 are contained in a single housing. Similarly, patient monitor device 112 and RAP 114 may be contained in a single housing.

RAP 106 and RAP 114 each include radio devices and one or more uplink ports. The radio devices may support one of a plurality of communication standards including cellular, WAN (wide-area network) and WiMAX (Worldwide Interoperability for Microwave Access). Other communication standards may be supported. The uplink ports may support a wired or wireless connection to the Internet via an Internet access device.

RAP 106 and RAP 114 are provisioned with access and authentication information that permits a secured tunneled connection to medical facility 120. In addition, once provisioned, the secure tunneled connection is always on when an uplink exists so that data from patient monitor devices 104, 112 are transmitted across Internet 118 to medical facility 120.

The example medical facility 120 includes an access point controller 122 and a server computer 124. The access point controller 122 controls a plurality of access points in medical facility 120 and permits a connection to server computer 124, as explained in more detail later herein. Server computer 124 is a server computer for the medical facility 120. For example, server computer 124 may process medical data received from patient monitor devices 104, 112 and may store patient identification information. In some examples, server computer 124 comprises a patient data server computer for medical facility 120. In other examples, server computer 124 may be part of electronic medical records (EMR) or an electronic health records (EHR) system for the medical facility 120.

Typically, server computer 124 is located at medical facility 120. However, in some examples, server computer 124 may be located at a site other than medical facility 120. More than one server computer 124 may be included in medical facility 120. In this disclosure, access point controller 122 may be referred to as controller 122.

Server computer 124 also supports a display of medical data received from patient monitor devices 104, 112 or from other patient monitor devices. In some examples, server computer 124 may include a display device. In other examples, server computer 124 may send received medical data to one or more electronic devices for display of the medical data. For example, the received medical data may be displayed on one or more of a personal computer, a tablet computer, a personal digital assistant, a smart telephone or other similar device that includes a display.

The medical data may include waveforms, location, numerics, trends of numerics, pain levels, alarm history, medication history and other related data for physiological parameters monitored by medical sensor devices at remote locations 102, 110. Examples of numerics include temperature, weight, fluid in/out values, SPO2 saturation levels, heart-rate, end-tidal CO2 levels, and respiration rate. Other numerics are possible. The medical data may be also be stored on server computer 124 and/or transmitted from server computer 124. In some examples, server computer 124 may be a virtual server computer.

Server computer 124 may also receive information about the medical sensor devices. Examples of the medical sensor devices include blood pressure measurement devices, oxygen saturation sensors, ECG sensors, etc. The information for the medical sensor devices may include serial number, software version, model, manufacturer, etc. This information may permit evaluation of the quality of the received medical data and may permit normalization of the received data. For example, consumer-grade blood pressure devices may not have the same accuracy as a medical-grade blood pressure device that has undergone performance testing to the ANSI/AAMI SP10 standard. Normalization may adjust readings from a consumer-grade medical sensor device to conform to a standard of a medical-grade medical sensor device.

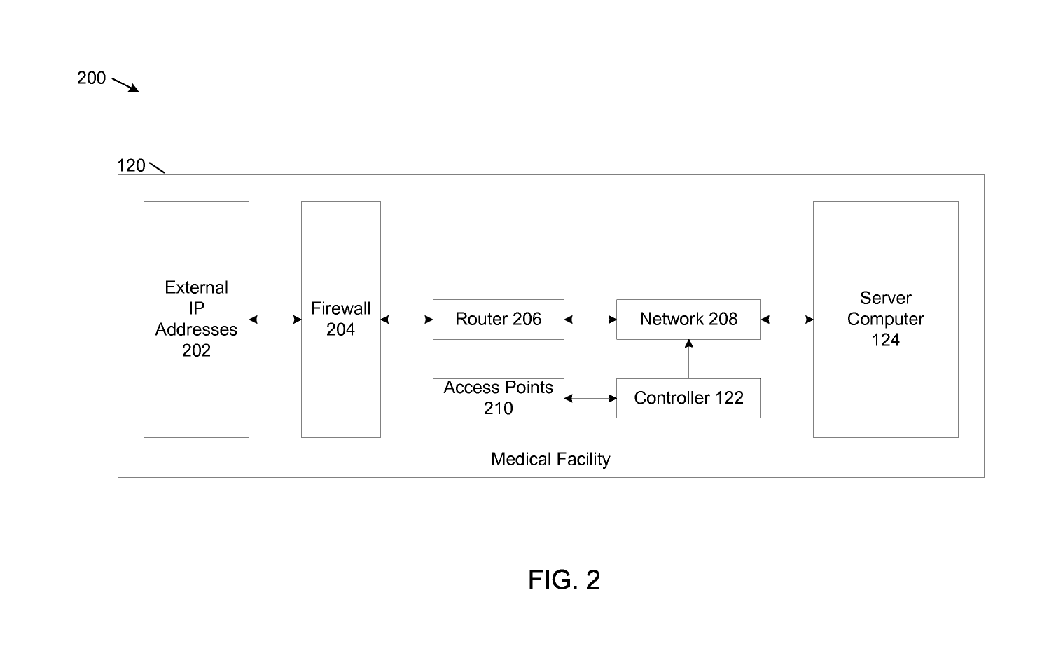

FIG. 2 shows a more detailed view of example components 200 of medical facility 120. The example medical facility 120 includes external IP addresses 202, firewall 204, router 206, internal network 208, controller 122, access points 210 and server computer 124. The external IP addresses 202 are a plurality of IP addresses for medical facility 120. The external IP addresses are visible outside of the medical facility 120 and provide a means of connecting to medical facility 120 from outside of the medical facility 120. A VPN connection request may be sent from RAP 106 or RAP 114 to any of the external IP addresses 202.

The example firewall 204 prevents unauthorized access to the medical facility 120. RAPs 106, 114 and/or firewall 204 and/or controller 122 are configured with policy information that provides permits access through firewall 204 to controller 122. The VPN connection request is passed through firewall 204 to router 206.

Router 206 is an electronic computing device that directs the connection request to controller 122. Router 206 is typically configured to map received VPN requests and data received on one of the external IP addresses 202 to controller 122. Controller 122 is an electronic computing device that controls a plurality of access points 210 in the medical facility 120 and that controls RAPs external to the medical facility. Each of access points 210 provides access to resources in medical facility 120, including to server computer 124. Controller 122 also provides configuration information for the plurality of access points 210 and may also provide configuration information for RAPs 106, 114.

Controller 122 receives data from one of access points 210 that provide wireless access to network 208 including server computer 124. The identified access point provides wired or wireless access to server computer 124. When the VPN connection request is from RAP 106, data from patient monitor device 104 is tunneled through the VPN to controller 122 where the VPN tunnel terminates. Controller 122 then processes the packet and forwards the packet to a final destination, in this example to server computer 124. Similarly, when the VPN connection request is from RAP 114, data from patient monitor device 112 is tunneled through the VPN to controller 122. Typically, data is tunneled to server computer 124 via the access point identified by controller 122. The access point identified by controller 122 is typically on a same local area network (LAN) segment as controller 122.

A network configuration as seen by a client device of access points 210 is a same network configuration as for RAP 106 and RAP 114. Example client devices are patient monitor device 104 and patient monitor device 112. In other words, RAP 106 and RAP 114 are configured such that the client device is moved to medical facility 120 instead of being at remote location 102 or remote location 110, respectively, medical data could still be transferred from patient monitor device 104 and patient monitor device 112, respectively, to server computer 124. Moreover, the client devices do not differentiate between RAPS 106 and 114 and access points 210.

In an example scenario, a patient monitor device 104 may be located in a patient's home. RAP 106 may also be located in the patient's home. Medical data from patient monitor device 104 may be transmitted via RAP 106 to server computer 124. At some point, the patient may need to be transferred to an ambulance and taken to a hospital. In this example scenario, patient monitor device 104 has a wireless connection to RAP 106. Also, RAP 114 may be located in the ambulance.

As the patient and patient monitor device are moved from the patient's home to the ambulance, medical data is still being transmitted from patient monitor device 104 through RAP 106 to server computer 124. As the ambulance travels to the hospital, at some point patient monitor device 104 may become outside of a range of RAP 106. At this point, the connection between patient monitor device 104 and server computer 124 may switch from RAP 106 to RAP 114, while still transmitting medical data to server computer 124.

When the patient reaches the hospital, the patient along with patient monitor device 104 may be moved from the ambulance to the hospital. When the patient is being moved, medical data from patient monitor device 104 is still being transmitted via RAP 114 to server computer 124. At some point, the patient monitor device 104 may become out of range of RAP 114. At this point, the connection between patient monitor device 104 and server computer 124 is switched from RAP 114 to another access point within the hospital, all the while transmitting medical data from patient monitor device 104 to server computer 124. This is one example of how a seamless connection is maintained from a patient monitor device to a server computer using the system and methods of this disclosure. Other examples are possible.

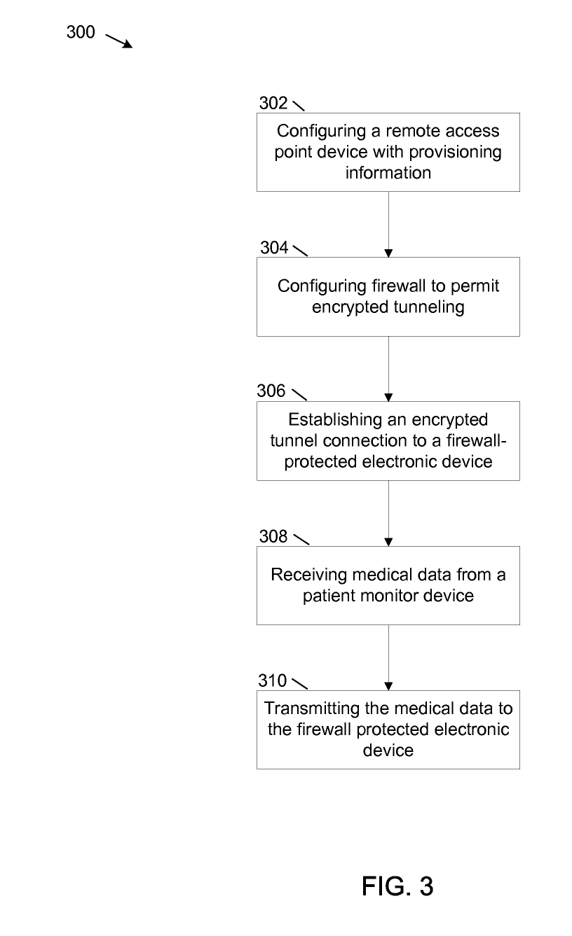

FIG. 3 shows an example flowchart for a method 300 for securely transferring medical data from a patient monitor device at a remote location to a server computer at a medical facility. At operation 302, a remote access point device at the remote location is configured with provisioning information. The provisioning information may include such items as an authentication method, encryption information, authentication credentials, and RF settings such as a DTIM interval, transmission power and regulatory constraint elements. In some examples the remote access point device may be pre-configured with the provisioning information. For example, the remote access point device may be provisioned at a factory or other location. In some examples, the remote location is at a fixed location such as a home or a mall. In other examples, the remote location is a medical transport such as an ambulance.

At operation 304, a firewall is configured on a firewall-protected network. In example method 300, the firewall-protected network is the firewall-protected network for medical facility 120. The firewall is configured to permit communication from an external IP address to a controller on the firewall-protected network. The firewall is configured to permit the communication on a specific port number used by the remote access point and the controller and for a specific protocol used by the remote access point and the controller.

At operation 306, an encrypted tunnel is established between the remote access point and an electronic computing device on the firewall-protected network. The encrypted tunnel provides a secure connection between the remote access point and the electronic computing device on the firewall-protected network. An example of an encrypted tunnel used in this disclosure is a VPN. In some examples, the encrypted tunnel is automatically established when the remote access point is installed at the remote location, using configuration information that is pre-provisioned in the remote access point. In other examples, the remote access point is provisioned at the remote location and the encrypted tunnel is established after the remote access point is provisioned. The electronic computing device on the firewall-protected network is typically an access point controller device. The access point controller device manages one or more access points on the firewall-protected network.

At operation 308, medical data is received at the remote access point from a patient monitor device. The patient monitor device is connected to the remote access point. The connection from the patient monitor device to the remote access point may be either a wired or a wireless connection.

At operation 310, the remote access point automatically transmits the received medical data to the electronic computing device on the firewall-protected network using the VPN. The remote access point may have a wired or wireless connection to the Internet at the remote location.

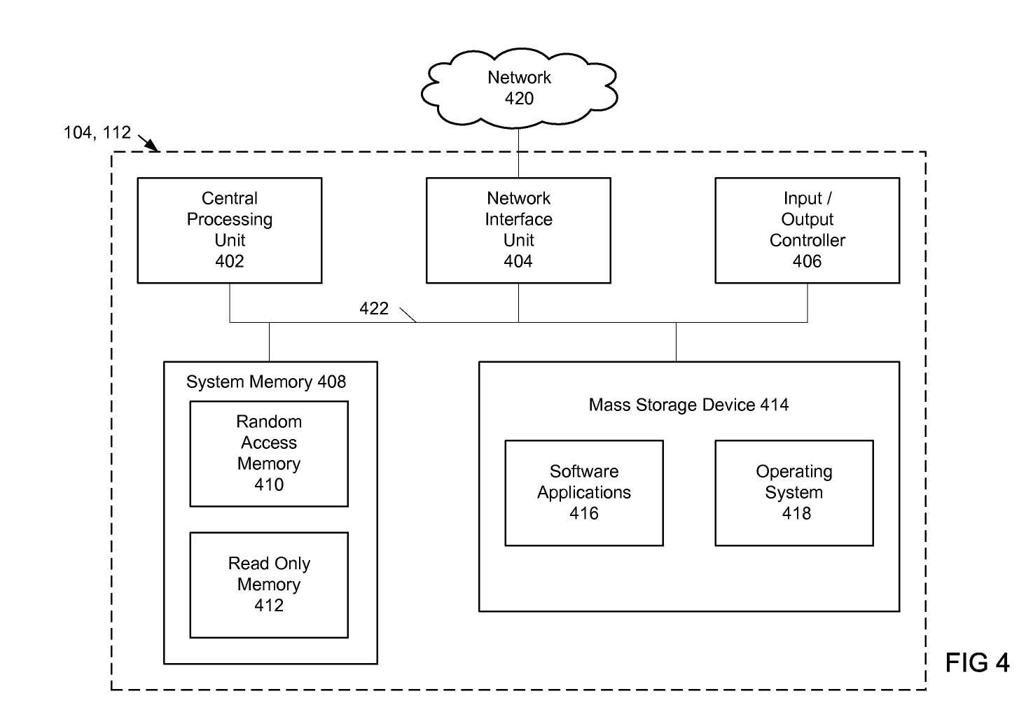

FIG. 4 illustrates example physical components of a patient monitor device, for example patient monitor device 104 or 112. As illustrated in the example of FIG. 4, patient monitor device 104 includes at least one central processing unit (“CPU”) 402, a system memory 408, and a system bus 422 that couples the system memory 408 to the CPU 402. The system memory 408 includes a random access memory (“RAM”) 410 and a read-only memory (“ROM”) 412. A basic input/output system contains the basic routines that help to transfer information between elements within the patient monitor device 104, such as during startup, is stored in the ROM 412. The patient monitor device 104 further includes a mass storage device 414. The mass storage device 414 is able to store software instructions and data.

The mass storage device 414 is connected to the CPU 402 through a mass storage controller (not shown) connected to the bus 422. The mass storage device 414 and its associated computer-readable data storage media provide non-volatile, non-transitory storage for the patient monitor device 104. Although the description of computer-readable data storage media contained herein refers to a mass storage device, such as a hard disk or solid state disk, it should be appreciated by those skilled in the art that computer-readable data storage media can be any available non-transitory, physical device or article of manufacture from which the central display station can read data and/or instructions.

Computer-readable data storage media include volatile and non-volatile, removable and non-removable media implemented in any method or technology for storage of information such as computer-readable software instructions, data structures, program modules or other data. Example types of computer-readable data storage media include, but are not limited to, RAM, ROM, EPROM, EEPROM, flash memory or other solid state memory technology, CD-ROMs, digital versatile discs (“DVDs”), other optical storage media, magnetic cassettes, magnetic tape, magnetic disk storage or other magnetic storage devices, or any other medium which can be used to store the desired information and which can be accessed by the patient monitor device 104.

According to various embodiments of the invention, the patient monitor device 104 may operate in a networked environment using logical connections to remote network devices through the network 420, such as a local network, the Internet, or another type of network. The patient monitor device 104 may connect to the network 420 through a network interface unit 404 connected to the bus 422. It should be appreciated that the network interface unit 404 may also be utilized to connect to other types of networks and remote computing systems. The patient monitor device 104 also includes an input/output controller 406 for receiving and processing input from a number of other devices, including a keyboard, a mouse, a touch user interface display screen, or another type of input device. Similarly, the input/output controller 406 may provide output to a touch user interface display screen, a printer, or other type of output device.

As mentioned briefly above, the mass storage device 414 and the RAM 410 of the patient monitor device 104 can store software instructions and data. The software instructions include an operating system 418 suitable for controlling the operation of the patient monitor device 104. The mass storage device 414 and/or the RAM 410 also store software instructions, that when executed by the CPU 402, cause the patient monitor device 104 to provide the functionality of the patient monitor device 104 discussed in this document. For example, the mass storage device 414 and/or the RAM 410 can store software instructions that, when executed by the CPU 402, cause the patient monitor device 104 to display received physiological data on a display screen of the patient monitor device 104.

The physical components shown in FIG. 4 may also apply to an access point device, for example to RAP 106 and RAP 114 and to a server computer, for example to server computer 124.

Although various embodiments are described herein, those of ordinary skill in the art will understand that many modifications may be made thereto within the scope of the present disclosure. Accordingly, it is not intended that the scope of the disclosure in any way be limited by the examples provided.

What is claimed is:

1. A method for securely transmitting medical data to and from a remote location, the method comprising:
configuring a first electronic computing device with provisioning information to access a firewall-protected electronic data network;
receiving at the first electronic computing device medical data from a second electronic computing device; and
transmitting the medical data to the firewall-protected electronic data network using the first electronic computing device,
wherein the provisioning information permits a secure connection between the second electronic computing device and a third electronic computing device on the firewall-protected electronic data network.

2. The method of claim 1, wherein the provisioning information includes authentication credentials.

3. The method of claim 1, wherein transmitting the medical data to the firewall-protected electronic data network using the provisioning information comprises establishing an encrypted tunnel between the first electronic computing device and third electronic computing device.

4. The method of claim 1, wherein the provisioning information includes an Internet Protocol (IP) address for the third electronic computing device.

5. The method of claim 1, wherein the first electronic computing device and the second electronic computing device are located in a stationary remote location.

6. The method of claim 1, wherein the first electronic computing device and the second electronic computing device are mobile.

7. The method of claim 6, wherein the first electronic computing device and the second electronic computing device are located in a medical transport.

8. The method of claim 1, wherein a network configuration of the first electronic computing device is identical to a network configuration of a fourth electronic computing device on the firewall-protected electronic data network, the network configuration permitting access to a server computer on the firewall-protected electronic data network.

9. The method of claim 8, wherein a secure connection between the second electronic computing device and the third electronic computing device is maintained as the second electronic computing device is transferred to a location near the third electronic computing device or to a location near the fourth electronic computing device.

10. The method of claim 1, wherein a connection from the first electronic computing device to the Internet is a wireless connection.

11. The method of claim 1, wherein a connection from the first electronic computing device to the Internet is a wired connection.

12. The method of claim 1, wherein functionality of the first electronic computing device and the second electronic computing device are included in a single housing.

13. A patient monitoring system comprising:
a patient monitor device that includes a first radio device, the patient monitor device being located at a first location;
a first access point device that includes a second radio device and at least one uplink port, the first access point device being located at the first location, the first access point device being provisioned to include authentication credentials for supporting an automatic connection to a first electronic device at a second location; and
a second electronic device for receiving a connection from the uplink port, the second electronic device being located at the first location, the second electronic device supporting a connection to the Internet.

14. The system of claim 13, wherein the authentication credentials are a same set of authentication credentials that are used by a second access point device at the second location to connect to the first electronic device from the second location.

15. The system of 13, wherein the uplink port is a universal serial bus (USB) port and the second electronic device is a cellular modem.

16. They system of 13, wherein the uplink port is an integrated wide-area network (WAN) radio device.

17. The system of 13, wherein the uplink port is an Ethernet port and the second electronic device supports a LAN connection.

18. A method for securely transmitting medical data from a remote location, the method comprising:
at the remote location, installing a remote access electronic computing device, the remote access electronic computing device being provisioned with access and authentication information for accessing a firewall protected computer network;
after the remote access electronic computing device is installed, establishing an encrypted tunnel connection from the remote access electronic computing device to an electronic computing device on the firewall protected computer network;
at the remote location, establishing a connection between a patient monitor device and the remote access electronic computing device; and
transmitting medical data from the patient monitor device to the remote access electronic computing device,
wherein, when the medical data is received at the remote access electronic computing device, the medical data is transmitted on the encrypted tunnel connection to the electronic computing device on the firewall protected computer network.

19. The method of claim 18, wherein the encrypted tunnel connection comprises a virtual private network (VPN).

20. The method of claim 18, wherein the encrypted tunnel connection is maintained when the patient monitor device is transferred from the remote location to a facility that houses the electronic computing device on the firewall protected computer network.
